(19) United States
(12) Patent Application Publication
(10) Pub. No.: US 2026/0107008 A1
(43) Pub. Date: Apr. 16, 2026

(54) AFFINE MOTION BASED PREDICTION IN VIDEO CODING

(71) Applicant: MEDIATEK INC., Hsinchu City (TW)

(72) Inventors: Yi-Wen CHEN, San Jose, CA (US); Chih-Hsuan LO, Hsinchu City (TW); Olena CHUBACH, San Jose, CA (US); Ching-Yeh CHEN, Hsinchu City (TW); Chih-Wei HSU, Hsinchu City (TW); Tzu-Der CHUANG, Hsinchu City (TW)

(21) Appl. No.: 19/117,233

(22) PCT Filed: Oct. 7, 2023
(86) PCT No.: PCT/CN2023/123215

§ 371 Date: Mar. 31, 2025

Related U.S. Application Data
(60) Provisional application No. 63/378,245, filed on Oct. 4, 2022.
(60) Provisional application No. 63/387,530, filed on Dec. 15, 2022.

(51) Int. Cl. H04N 19/51; H04N 19/103

(52) U.S. Cl. CPC H04N 19/51; H04N 19/103

(57) ABSTRACT

A method for performing affine motion compensation prediction (MCP) in a video decoder is provided. The method includes selecting an affine MCP mode from an affine MCP mode candidate set. The method also includes performing, based on the selected affine MCP mode, affine motion compensation prediction in the video decoder. For a coding unit with both a width and a height larger than a first threshold, a first affine MCP mode candidate set is applied. For a coding unit with at least one of a width and a height not larger than the first threshold, a second affine MCP mode candidate set is applied. The first affine MCP mode candidate set has more affine MCP mode candidates than the second affine MCP mode candidate set.

### CROSS REFERENCE TO RELATED APPLICATIONS

This present application claims the benefit of provisional Applications No. 63/378,245, filed on Oct. 4, 2022, and No. 63/387,530, filed on Dec. 15, 2022. The disclosures of both prior applications are incorporated herein by reference in their entirety.

### TECHNICAL FIELD

The present disclosure relates generally to video coding. In particular, the disclosure relates to the utilization of affine-based motion compensation within video encoding and decoding systems.

### BACKGROUND

In the High-Efficient Video Coding (HEVC) standard, only translation motion models are applied for motion compensation prediction (MCP). However, in real-world scenarios, various types of motion may occur, e.g., zoom in/out, rotation, perspective motions, and other irregular motions. To address this, the Versatile Video Coding (VVC) standard applies block-based affine transform motion compensation prediction. By introducing affine prediction, the 2D translations (two degrees of freedom) can be extended to more degrees of freedom.

### SUMMARY

Aspects of the disclosure provide a method for performing affine motion compensation prediction (MCP) in a video decoder. The method includes selecting an affine MCP mode from an affine MCP mode candidate set. The method also includes performing, based on the selected affine MCP mode, affine motion compensation prediction in the video decoder. For a coding unit with both a width and a height larger than a first threshold, a first affine MCP mode candidate set is applied. For a coding unit with at least one of a width and a height not larger than the first threshold, a second affine MCP mode candidate set is applied. The first affine MCP mode candidate set has more affine MCP mode candidates than the second affine MCP mode candidate set.

Aspects of the disclosure provide another method for performing affine motion compensation prediction (MCP) in a video encoder. The method includes selecting an affine MCP mode from an affine MCP mode candidate set. The method also includes performing, based on the selected affine MCP mode, affine motion compensation prediction in the video encoder. For a coding unit with both a width and a height larger than a first threshold, a first affine MCP mode candidate set is applied. For a coding unit with at least one of a width and a height not larger than the first threshold, a second affine MCP mode candidate set is applied. The first affine MCP mode candidate set has more affine MCP mode candidates than the second affine MCP mode candidate set.

Aspects of the disclosure provide an apparatus for performing affine motion compensation prediction (MCP) in a video decoder. The apparatus includes circuitry configured to select an affine MCP mode from an affine MCP mode candidate set, and perform, based on the selected affine MCP mode, affine motion compensation prediction in the video decoder. For a coding unit with both a width and a height larger than a first threshold, a first affine MCP mode candidate set is applied. For a coding unit with at least one of a width and a height not larger than the first threshold, a second affine MCP mode candidate set is applied. The first affine MCP mode candidate set has more affine MCP mode candidates than the second affine MCP mode candidate set.

An apparatus for performing affine motion compensation prediction (MCP) in a video decoder. The apparatus includes circuitry configured to select an affine MCP mode from an affine MCP mode candidate set; and perform, based on the selected affine MCP mode, affine motion compensation prediction in the video decoder. For a coding unit with both a width and a height larger than a first threshold, a first affine MCP mode candidate set is applied. For a coding unit with at least one of a width and a height not larger than the first threshold and the width is larger than or equal to the height, a second affine MCP mode candidate set is applied. For a coding unit with at least one of a width and a height not larger than the first threshold and the width is less than the height, a third affine MCP mode candidate set is applied.

### BRIEF DESCRIPTION OF THE DRAWINGS

Various embodiments of this disclosure that are proposed as examples will be described in detail with reference to the following figures, wherein like numerals reference like elements, and wherein:

FIGS. 1A-1B illustrate a 4-parameter affine motion model and a 6-parameter affine motion model, which are based on two control points and three control points, respectively;

FIG. 2 illustrates an affine motion vector field (MVF) for each subblock;

FIG. 3 shows different scenarios with coding unit sizes of 8×8 and 4×4;

FIG. 4 shows scenarios where the coding unit has sizes of 8×8 and 4×4, according to an embodiment of this disclosure;

FIG. 5 shows a flow chart of a process for performing affine motion compensation prediction (MCP) in a video encoder or a video decoder, in accordance with embodiments of the disclosure;

FIG. 6 shows multi-type tree splitting modes;

FIG. 7 shows an example of a quadtree with a nested multi-type tree coding block structure;

FIGS. 8A and 8B show a search points layout in merge mode with motion vector difference (MMVD);

FIG. 9 shows locations of inherited affine motion predictors;

FIG. 10 shows an example of control point motion vector inheritance;

FIG. 11 shows locations of candidate positions for constructed affine merge mode;

FIG. 12 shows subblock MV VSB and pixel Δv(i,j) (the broken-line arrow);

FIG. 13 shows an example of decoding side motion vector refinement;

FIG. 14 shows examples of the geometric partition mode (GPM) splits grouped by identical angles;

FIG. 15 shows top and left neighboring blocks used in combined inter-intra prediction (CIIP) weight derivation;

FIG. 16 shows template matching performed on a search area around initial MV;

FIG. 17 shows diamond regions in the search area;

FIG. 18 shows nominal vertical and horizontal locations of 4:2:0 luma and chroma samples in a picture;

FIG. 19 shows nominal vertical and horizontal locations of 4:2:2 luma and chroma samples in a picture;

FIG. 20 shows nominal vertical and horizontal locations of 4:4:4 luma and chroma samples in a picture;

FIG. 21 shows template and reference samples of the template in reference pictures;

FIG. 22 shows template and reference samples of the template for block with sub-block motion using the motion information of the subblocks of the current block;

FIG. 23 shows additional directions along k×π/8 diagonal angles (the positions filled with the darkest texture are used in the anchor);

FIG. 24 shows a 4×8 luma block and a 2×4 chroma block when the input video is 4:2:0 chroma sampling;

FIG. 25 shows a block diagram of a video encoder according to an embodiment of the disclosure; and

FIG. 26 shows a block diagram of a video decoder according to an embodiment of the disclosure.

### DETAILED DESCRIPTION OF EMBODIMENTS

The following disclosure provides different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

In this disclosure, unless explicitly stated otherwise, the size of a coding unit (CU) is expressed in terms of luma samples contained in that CU. Additionally, the size of a luma (or chroma) block is given in the unit of luma (or chroma) samples within that block. Moreover, the size of a coding unit or a block can be denoted as W×H, where W represents the number of samples in the width direction, while H represents the number of samples in the height direction.

This disclosure relates to enhanced affine motion compensation prediction (MCP) used in video encoding and decoding systems. The enhanced affine-based MCP can be applied to small CU sizes, and parsing of the related syntax elements can be simplified.

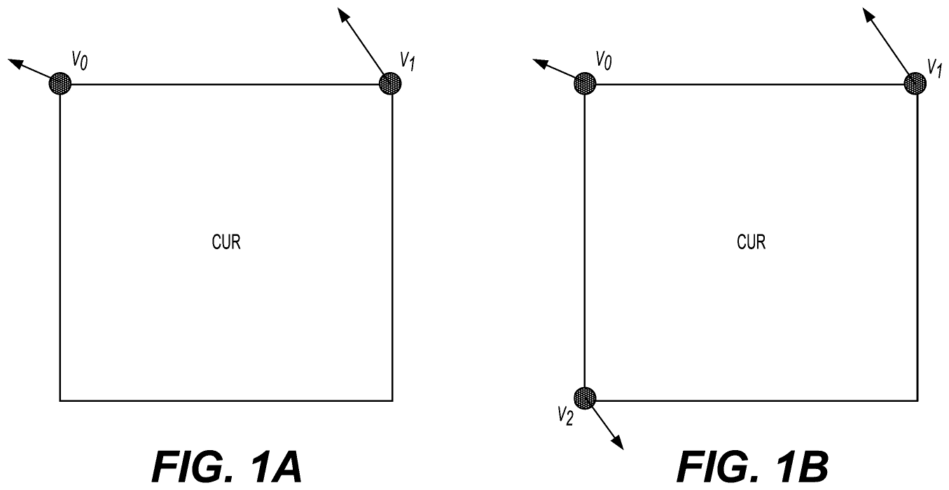

FIGS. 1A-1B illustrate a 4-parameter affine motion model and a 6-parameter affine motion model, which are based on two control points and three control points, respectively. The affine motion field of the current block can be characterized by motion information derived from the motion vectors of two control points (for the 4-parameter model) or three control points (for the 6-parameter model).

According to the 4-parameter affine motion model, the motion vector at a sample location (x,y) in the current block can be calculated as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix}$$

According to the 6-parameter affine motion model, the motion vector at the sample location (x,y) in the current block can be calculated as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix}$$

In these equations, (mv₀ₓ, mv_{0y}) is the motion vector of the top-left corner control point v₀, (mv₁ₓ, mv₁ₓ) is the motion vector of the top-right corner control point v₁, and (mv₂ₓ, mv_{2y}) is the motion vector of the bottom-left corner control point v₂.

Similar to translational motion inter prediction, two basic affine motion inter prediction modes, i.e., the affine Merge mode and the affine Advanced Motion Vector Prediction (AMVP) mode, can be used to generate motion vectors for affine motion compensation. The affine Merge mode uses motion information from spatial neighboring blocks to generate control point motion vectors (CPMVs) for the current CU. In the affine AMVP mode, the difference between vectors of the current CU and their predictors is transmitted in the bitstream.

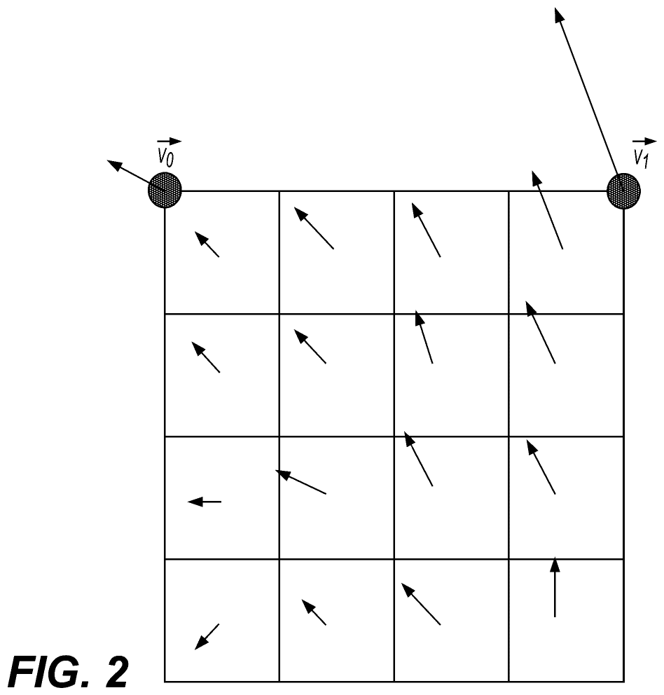

Furthermore, subblock-based affine transform prediction can be utilized to simplify the motion compensation prediction. FIG. 2 illustrates an affine motion vector field (MVF) for each subblock. As shown in FIG. 2, to obtain the motion vector of each luma subblock with a size of e.g., 4×4, the motion vector of the center sample of each subblock is calculated using the above equations and rounded to 1/16 fraction accuracy. Then, motion compensation interpolation filters can be applied to generate the prediction for each subblock using the derived motion vector. The subblock size for chroma-components can also be set to be 4×4. The motion vector of the 4×4 chroma subblock is calculated as the average of the motion vectors of the top-left and bottom-right luma subblocks in the collocated 8×8 luma region.

Typically, the existing video codecs define the smallest size of coding blocks. For instance, in Enhanced Compression Model (ECM) 6.0, the smallest block size for regular inter modes is defined as a 4×4 luma block. In the case of VVC, when using the 4:2:0 chroma sampling format, the smallest chroma block size for regular inter modes is set as 2×2. For subblock-based affine motion compensation of luma components and chroma components, the smallest subblock size is predefined in ECM 6.0 as 4×4, for example.

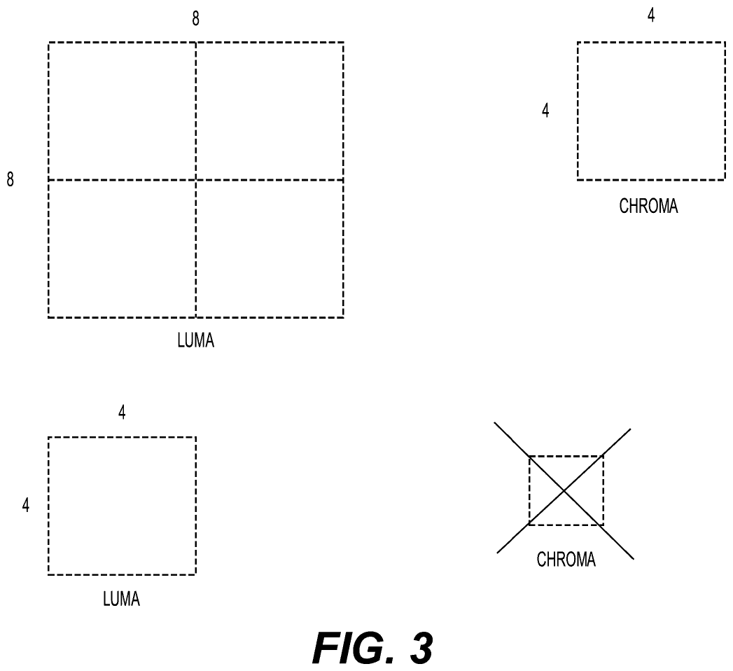

In some examples, the affine Merge/AMVP mode is limited to coding units with both a width and height equal to or larger than 8. FIG. 3 shows different scenarios with coding unit sizes of 8×8 and 4×4. In the case of larger blocks, such as the illustrated 8×8 luma block, the corresponding two chroma blocks each have a size of 4×4, satisfying the requirement of the smallest subblock size of 4×4 for applying affine motion compensation as defined in the affine Merge/AMVP mode. However, for smaller blocks, such as the illustrated 4×4 luma block, the corresponding chroma blocks become too small (i.e., 2×2). The affine motion compensation as defined in the affine Merge/AMVP mode cannot be applied.

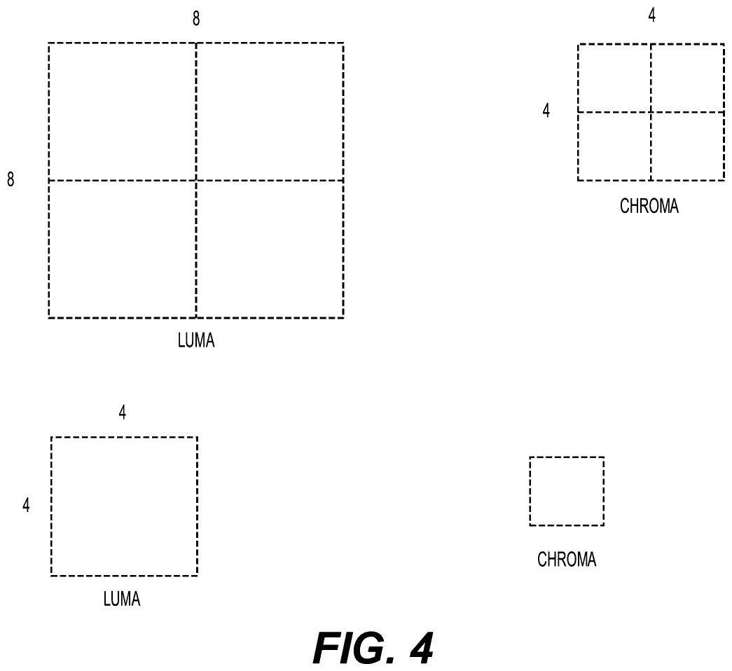

According to embodiments of this disclosure, the smallest block size for the affine Merge and/or Affine AMVP modes can be aligned with the smallest block size allowed for the regular Merge and/or regular AMVP mode. FIG. 4 shows scenarios where the coding unit has sizes of 8×8 and 4×4, according to an embodiment of this disclosure. Instead of using the 4×4 subblock size for the chroma components, smaller subblock sizes are permitted, based on the adopted chroma sampling format. For example, the chroma components can have a smallest subblock size of 2×2. This allows enabling the affine Merge and/or AMVP modes on smaller coding units where the width and/or height is less than 8.

It is noted that in the existing codecs, the smallest CU for regular inter mode is typically 4×4. If even smaller CU sizes, such as 2×2 and 1×1, are allowed for the regular inter mode in the future, the approaches described in this disclosure can be adapted accordingly to accommodate the new developments in CU sizes.

According to an embodiment, the affine Merge and/or affine AMVP modes are allowable on small blocks such as 4×N or N×4 CUs, and a 4:2:0 chroma sampling format is adopted, where N is a power of 2, and N≥4. In this case, the corresponding chroma block size is 2×(N/2) or (N/2)×2. Thus, the size of the chroma subblock for affine motion compensation need to be modified.

As an example, in the subblock-based affine motion compensation, a 4×4 luma subblock size and a 2×2 chroma subblock size can be always used. Alternatively, different chroma subblock sizes can be adopted for different CU sizes.

For example, for a coding unit having a size equal to 4×N or N×4, the subblock size for luma components can be 4×4, while the subblock size for chroma components can be 2×2. Additionally, for a coding unit having a width larger than 4 and a height larger than 4, a subblock size of 4×4 can be used for both luma components and chroma components.

In another example, when the coding unit has a size of 4×4, the luma subblock size can be 4×4, while the chroma subblock size can be 2×2. If the coding unit has a size equal to 4×N, a subblock size of 2×4 can be used for chroma components. If the coding unit has a size equal to N×4, a subblock size of 4×2 can be used for chroma components. For coding units having a width larger than 4 and a height larger than 4, a subblock size of 4×4 can be used for both luma components and chroma components.

According to another embodiment, the affine Merge and/or affine AMVP modes are allowable on small blocks such as 4×N or N×4 CUs, and a 4:2:2 chroma sampling format is adopted, where N is a power of 2, and N≥4. In this case, the corresponding chroma block size is 2×(N) and (N/2)×4. As mentioned before, since a subblock size of 4×4 is too large for chroma components, an adjusted smallest chroma subblock size can be used to enable affine motion compensation.

In one example, in the subblock-based affine motion compensation, a 4×4 luma subblock size and a 2×4 chroma subblock size can always be used. Alternatively, different chroma subblock sizes can be adopted for different CU sizes.

For example, for a coding unit having a size equal to 4×N or N×4, the subblock size for luma components can be 4×4, while the subblock size for chroma components can be 2×4. Additionally, for a coding unit having a width larger than 4 and a height larger than 4, a subblock size of 4×4 can be used for both luma components and chroma components.

In another example, when the coding unit has a size of 4×N, the luma subblock size can be 4×4, and the chroma subblock size can be 2×4. If the coding unit has a size equal to N×4, where N>4, the luma subblock size can be 4×4, and the chroma subblock size also can be 4×4. For coding units having a width larger than 4 and a height larger than 4, a subblock size of 4×4 can be used for both luma components and chroma components.

According to another embodiment, the affine Merge and/or affine SMVP modes are allowable on small blocks such as 4×N or N×4 CUs, and a 4:4:4 chroma sampling format is adopted, where N is a power of 2, and N≥4. In this case, the corresponding chroma block size is 4×N or N×4.

As an example, in the subblock-based affine motion compensation, a 4×4 luma subblock size and a 2×2 chroma subblock size can be always used. Alternatively, different chroma subblock sizes can be adopted for different CU sizes.

For example, for a coding unit having a size equal to 4×N or N×4, the subblock size for luma components can be 4×4, while the subblock size for chroma components can be 2×2. Additionally, for a coding unit having a width larger than 4 and a height larger than 4, a subblock size of 4×4 can be used for both luma components and chroma components.

In another example, when the coding unit has a size of 4×4, the luma subblock size can be 4×4, and the chroma subblock size can be 2×2. If the coding unit has a size equal to 4×N, where N>4, a subblock size of 2×4 can be used for chroma components. If the coding unit has a size equal to N×4, where N>4, a subblock size of 4×2 can be used for chroma components. For coding units having a width larger than 4 and a height larger than 4, a subblock size of 4×4 can be used for both luma components and chroma components.

As mentioned above, Versatile Video Coding (VVC) and ECM 6.0 provide the flexibility to adaptively choose between the 6-parameter and 4-parameter affine models for an affine AMVP coded block. Compared with the 4-parameter affine AMVP mode, the 6-parameter affine AMVP mode requires more bits to signal the motion information. However, for small blocks where the motion is relatively simpler, it may not be necessary to use the more complex 6-parameter affine motion model.

As a result, by relaxing the constraint on the subblock size, it is possible to simplify the parsing of related syntax elements. Since a simpler 4-parameter model is sufficient to characterize the motion patterns of a small block, there is no need to include syntax element(s) indicating the choice between the 4-parameter and the 6-parameter affine motion models. Additionally, signaling the information related to the 4-parameter model requires fewer bits compared to the 6-parameter model.

According to an embodiment of the disclosure, when applying the affine motion model in the affine AMVP mode to small coding units, such as those with a size of 4×N or N×4, where N is a power of 2, and N≥4, the use of the 4-parameter affine motion model is automatically inferred for the current CU. Therefore, the specific syntax element(s) for indicating the selection of the 4-parameter or 6-parameter affine motion model can be omitted. Furthermore, only two control point motion vectors need to be signaled, leading to a reduction in the number of transmitted bits.

One skilled in the art can identify various changes, modifications, and alternatives to simplify the syntax elements signaling. For example, instead of the 4-parameter affine motion model, the 6-parameter affine motion model can be automatically inferred for small CUs, with only two control point motion vectors being signaled. The third control point motion vector can then be derived from the signaled control point motion vectors. For instance, in the case of N×4 CUs, only the top-left and top-right control point motion vectors are required to be signaled, while for 4×N CUs, only the top-left and bottom-left control point motion vectors need to be signaled.

As another example, for a small coding unit (e.g., a N×4 CU) with the width larger than or equal to the height, the 4-parameter affine motion model can be used and motion vectors with respect to the top-left and the top-right control points are signaled; for a small coding unit (e.g., a 4×N CU) with the width less than to the height, the 4-parameter affine motion model can be used and motion vectors with respect to the top-left and the bottom-left control points are signaled.

It should be noted that these examples are merely illustrative, and other implementations are possible, without departing from the spirit and scope of this disclosure.

For instance, the small block can be defined as a coding unit with a width being smaller than or equal to L and a height being smaller than or equal to M, where L and M are non-negative integers. The values of L and M can be predefined, or signaled into the bitstream as syntax elements of the video coding standard. The syntax elements can be signaled at various levels, such as the sequence level (e.g., in the sequence parameter set), the picture level (e.g., in the picture parameter set), the slice level (e.g., in the slice header), the CTU level, the CU level, or the block level.

As an example, the 6-parameter affine AMVP mode and/or the affine MMVD mode can be disallowed for affine coded CUs/blocks with sizes of 4×4, 4×2, or 2×4. However, for CUs with a size of 4×N or N×4, where N is a power of 2, and N>4, the 6-parameter affine AMVP mode and the affine MMVD mode can be allowed.

Alternatively or additionally, the affine Merge with Motion Vector Difference (MMVD) mode can also be disallowed for small coding units, result in further simplification of the syntax element signaling.

Note that for small coding units, the 6-parameter affine motion model can still be allowed in the affine Merge mode, as it does not require more bits compared with the 4-parameter affine Merge mode.

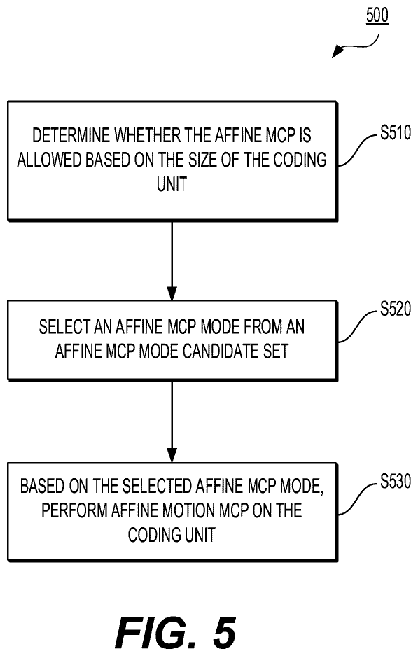

FIG. 5 shows a flow chart of a process for performing affine motion compensation prediction (MCP) in a video encoder, in accordance with embodiments of the disclosure. The process 500 starts at step 510 by determining, based on the size of the coding unit, whether the affine motion compensation prediction is allowed. When both the width and the height of the coding unit is equal to or larger than a threshold (e.g., 4), step S510 determines that the affine motion compensation prediction is allowed to be performed on the coding unit. When at least one of the width and the height of the coding unit is smaller than the second threshold, step S510 determines that the affine motion compensation prediction is not allowed to be performed on the coding unit.

In step S520, an affine MCP mode can be selected from an affine MCP mode candidate set. For a coding unit with both a width and a height larger than a threshold (e.g., 4), a first affine MCP mode candidate set is applied. For a coding unit with at least one of the width and the height not larger than the threshold, a second affine MCP mode candidate set is applied. The first affine MCP mode candidate set can have more affine MCP mode candidates than the second affine MCP mode candidate set. For example, the 6-parameter affine AMVP mode and/or the affine MMVD mode can be included in the first affine MCP mode candidate set, but not in the second affine MCP mode candidate set.

In step S530, affine motion compensation prediction can be performed on the coding unit, based on the selected affine MCP mode.

Any of the foregoing proposed approaches and methods can be implemented in encoders and/or decoders. For example, any of the proposed approaches and methods can be implemented in inter prediction module of an encoder and/or a decoder. Alternatively, any of the proposed approaches and methods can be implemented as processing circuitry coupled to the inter prediction module of the encoder and/or the decoder.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

Aspects of the present disclosure can be further described as follows.

### I. Video Coding Methods

### 1. Partitioning of the CTUs Using a Tree Structure

In High-Efficient Video Coding standard (HEVC), pictures are divided into a sequence of coding tree units (CTUs). A CTU consists of an N×N block of luma samples together with two corresponding blocks of chroma samples for a picture that has three sample arrays, or an N×N block of samples of a monochrome plane in a picture that is coded using three separate colour planes. The CTU concept is broadly analogous to that of the macroblock in previous standards such as Advanced Video Coding (AVC). The maximum allowed size of the luma block in a CTU is specified to be 64×64 in Main profile. A CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four prediction units (PUs) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

Versatile Video Coding standard (VVC) is the successor to HEVC. In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure.

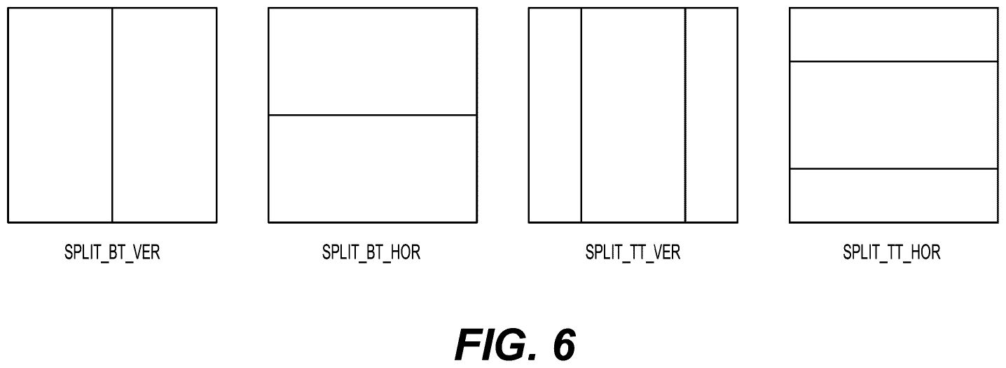

FIG. 6 shows multi-type tree splitting modes. As shown in FIG. 6, there are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

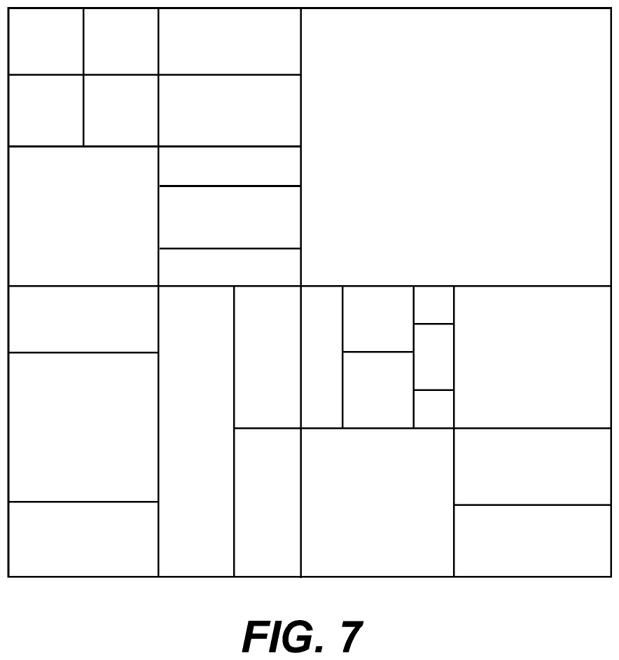

In FIG. 7, an example of quadtree with nested multi-type tree coding block structure are presented. FIG. 7 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma sampling format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. ECM basically is the successor to VVC and thus it shares many common parts as VVC.

### 2. Inter Prediction Overview

In HEVC, for each inter PU, one of three prediction modes including inter, skip, and merge, can be selected. Generally speaking, a motion vector competition (MVC) scheme is introduced to select a motion candidate from a given candidate set that includes spatial and temporal motion candidates. Multiple references to the motion estimation allows finding the best reference in 2 possible reconstructed reference picture list (namely List 0 and List 1). For the inter mode (unofficially termed AMVP mode, where AMVP stands for advanced motion vector prediction), inter prediction indicators (List 0, List 1, or bi-directional prediction), reference indices, motion candidate indices, motion vector differences (MVDs) and prediction residual are transmitted. As for the skip mode and the merge mode, only merge indices are transmitted, and the current PU inherits the inter prediction indicator, reference indices, and motion vectors from a neighboring PU referred by the coded merge index. In the case of a skip coded CU, the residual signal is also omitted.

In VVC, AMVP mode is further improved by the new modes such as symmetric motion vector difference (SMVD) mode, adaptive motion vector resolution (AMVR) and affine AMVP mode; Merge/Skip modes are further improved by enhanced merge candidates, combined inter-intra prediction (CIIP), affine merge mode, subblock temporal motion vector predictor (SbTMVP), merge mode with motion vector difference (MMVD) and geometric partition mode (GPM). In VVC, a decoder-side motion vector refinement (DMVR), Bi-directional optical flow (BDOF) and prediction refinement with optical flow (PROF) are utilized to refine the motion vectors or the motion-compensated predictors at the decoder.

In ECM, several new coding tools are developed to further improve the AMVP, Merge and Skip mode such as Bilateral matching AMVP-Merge mode, multi-hypothesis prediction (MHP), overlapped block motion compensation (OBMC) and so on. Furthermore, templating matching based decoder side motion vector refinement is also proposed to enhanced the coding efficiency of the inter prediction.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

After VVC is finalized, the Enhanced Compression Model (ECM) reference software is developed to study the potential need for standardization of future video coding technology. In current ECM, several inter-prediction coding tools are included to provide further BD-rate savings:
Local illumination compensation (LIC)
Non-adjacent spatial candidate
Template Matching (TM)
Overlapped Block Motion Compensation (OBMC)
Multi-hypothesis prediction (MHP)
Bilateral matching AMVP-Merge Mode
and so some other tools under development

The following text provides the details on some selected inter prediction methods specified in VVC and ECM.

### 3. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merge candidate lists (or called as merging candidate lists) for all CUs within a certain size of area.

### 4. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1) The last two entries in the table are redundancy checked to A₁ and B₁ spatial candidates, respectively.
2) Once the total number of available merge candidates reaches the maximally allowed merge candidates minus 1, the merge candidate list construction process from HMVP is terminated.

### 5. Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

6. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signaled right after sending a regular merge flag to specify whether MMVD mode is used for a CU.

In MMVD, after a merge candidate is selected, it is further refined by the signaled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signaled to specify which one is used between the first and second merge candidates.

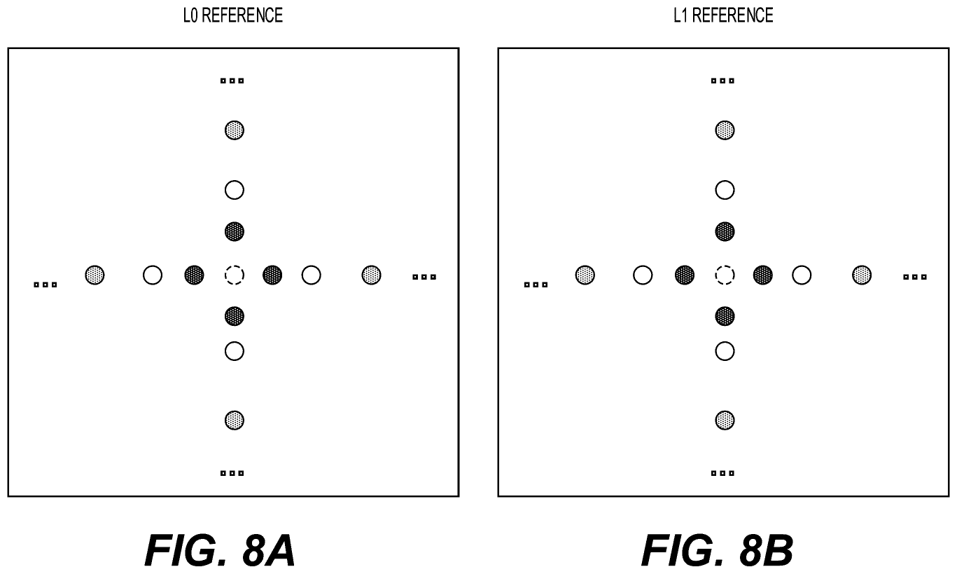

FIGS. 8A and 8B show MMVD Search Point. Distance index specifies motion magnitude information and indicate the pre-defined offset from the starting point. As shown in FIGS. 8A-8B, an offset is added to either horizontal component or vertical component of starting MV. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 7. Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIGS. 1A-1B show 4-parameter control-point-based affine motion model and 6-parameter control-point-based affine motion model. As shown FIGS. 1A-1B, the affine motion field of the block is described by motion information of two control point (4-parameter) or three control point motion vectors (6-parameter).

For 4-parameter affine motion model, motion vector at sample location (x,y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 X} - m {v}_{0 x}}{W} y + m {v}_{0 y}\end{matrix} \qquad ( 3 - 15 )$$

For 6-parameter affine motion model, motion vector at sample location (x,y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 3 - 16 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. FIG. 2 shows affine MVF per subblock. To derive motion vector of each 4×4 luma subblock, the motion vector of the center sample of each subblock, as shown in FIG. 2, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 8. Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs
Constructed affine merge candidates CPMVPs that are derived using the translational MVs of the neighbour CUs
Zero MVs

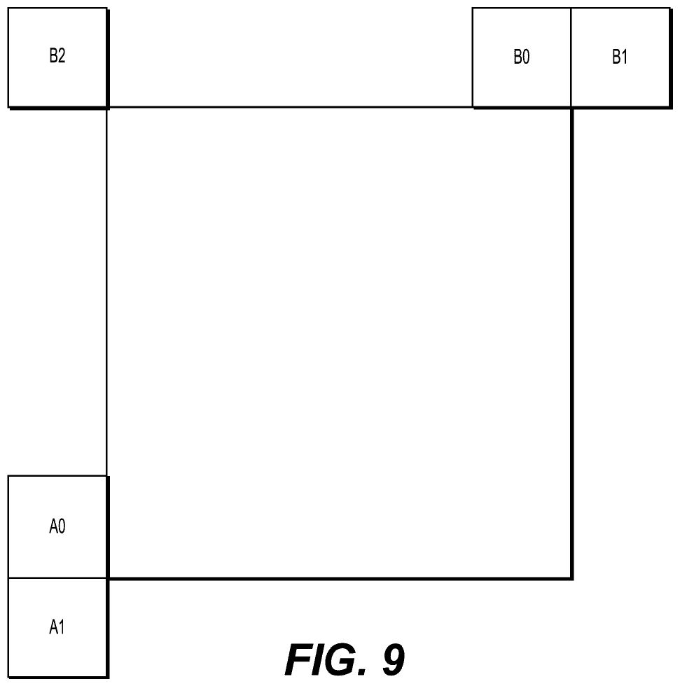

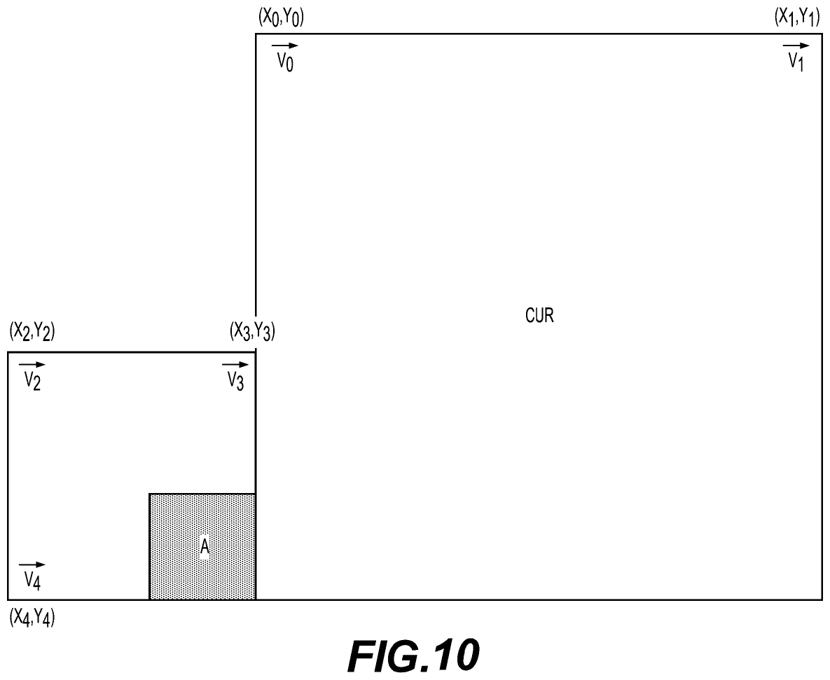

In VVC, there are maximum two inherited affine candidates, which are derived from affine motion model of the neighboring blocks, one from left neighboring CUs and one from above neighboring CUs. FIG. 9 shows Locations of inherited affine motion predictors. The candidate blocks are shown in FIG. 9. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. FIG. 10 shows Control point motion vector inheritance. As shown in FIG. 10, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

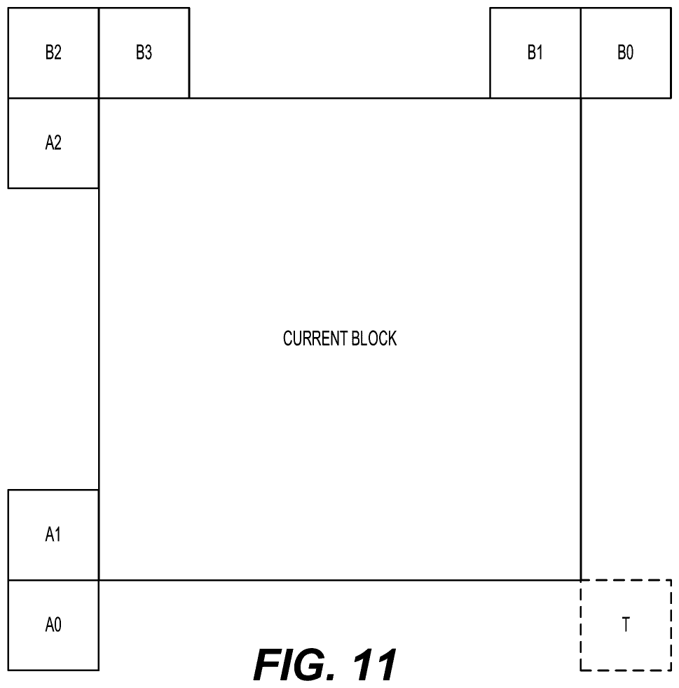

FIG. 11 shows locations of candidates position for constructed affine merge mode. Constructed affine candidate means the candidate is constructed by combining the neighbor translational motion information of each control point. The motion information for the control points is derived from the specified spatial neighbors and temporal neighbor shown in FIG. 11. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on those motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

9. Prediction Refinement with Optical Flow for Affine Mode (PROF)

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:
Step 1) The subblock-based affine motion compensation is performed to generate subblock prediction I(i,j).
Step2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) ≫ shift 1 ) - ( I ( i - 1 , j ) ≫ shift 1 ) \qquad ( 3 - 17 )$$

$${g}_{y} ( i , j ) = ( I ( i , j + 1 ) ≫ shift 1 ) - ( I ( i , j - 1 ) ≫ shift 1 ) \qquad ( 3 - 18 )$$

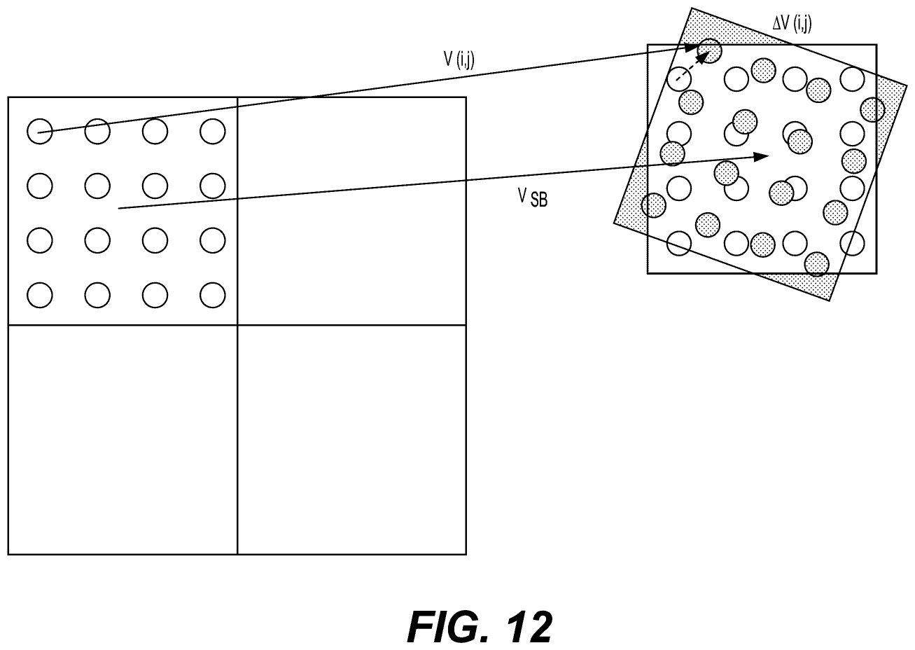

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.
Step 3) The luma prediction refinement is calculated by the following optical flow equation.

$$Δ l ( i , j ) = {g}_{x} ( i , j ) * Δ {v}_{x} ( i , j ) + {g}_{y} ( i , j ) * Δ {v}_{y} ( i , j ) \qquad ( 3 - 19 )$$

where the Δv(i,j) is the difference between sample MV computed for sample location (i,j), denoted by v(i,j), and the subblock MV of the subblock to which sample (i,j) belongs, as shown in FIG. 12. The Δv(i,j) is quantized in the unit of 1/32 luam sample precision.

FIG. 12 shows Subblock MV VSB and pixel Δv(i,j) (the broken-line arrow). Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB},y_{SB}), Δv(x,y) can be derived by the following equation,

$$\{ \begin{matrix}dx ( i , j ) = i - {x}_{S B} \\ dy ( i , j ) = j - {y}_{S B}\end{matrix} \qquad ( 3 - 20 )$$

$$\{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix} \qquad ( 3 - 21 )$$

In order to keep accuracy, the enter of the subblock (x_{SB},y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 3 - 22 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 3 - 23 )$$

where (v₀ₓ,v_{0y}), (v₁ₓ,v_{1y}), (v₂ₓ,v_{2y}) are the top-left, top-right and bottom-left control point motion vectors, w and h are the width and height of the CU.
Step 4) Finally, the luma prediction refinement ΔI(i,j) is added to the subblock prediction I(i,j). The final prediction I′ is generated as the following equation.

$${I}^{′} ( i , j ) = I ( i , j ) + Δ I ( i , j )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 10. Decoder Side Motion Vector Refinement (DMVR)

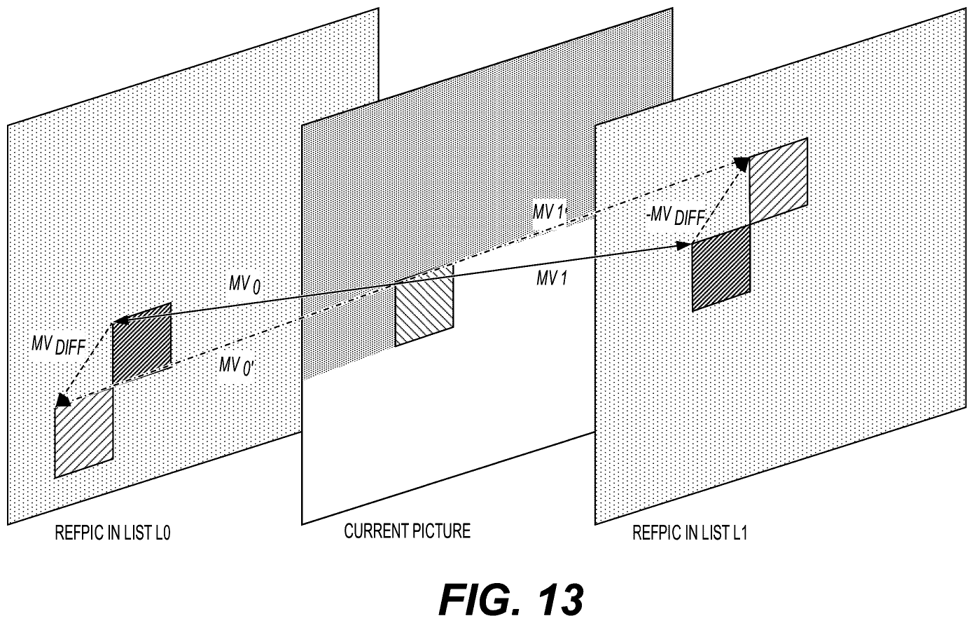

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 13 shows decoding side motion vector refinement. As illustrated in FIG. 13, the SAD between the blocks filled with sparser diagonal stripes based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 11. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6}excluding 8×64 and 64×8.

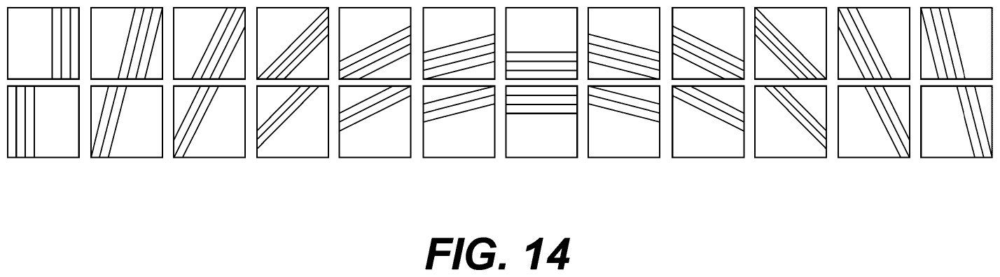

FIG. 14 shows examples of the GPM splits grouped by identical angles. When this mode is used, a CU is split into two parts by a geometrically located straight line (FIG. 14). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.11.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.11.2. This is the prediction signal for the whole CU, and transform and quantization process will be applied to the whole CU as in other prediction modes. Finally, the motion field of a CU predicted using the geometric partition modes is stored as in 3.4.11.3.

### 12. Combined Inter and Intra Prediction (CHIP)

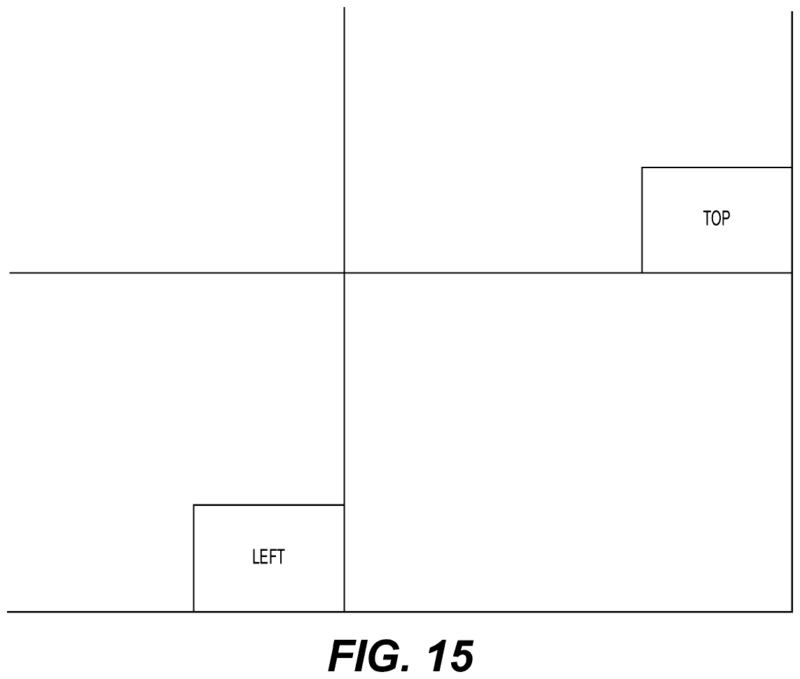

In VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the combined inter/intra prediction (CIIP) mode is applied to the current CU. FIG. 15 shows top and left neighboring blocks used in CIIP weight derivation. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 15) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + wt * {P}_{intra} + 2 ) ≫ 2 \qquad ( 3 - 43 )$$

### 13. Template Matching (TM)

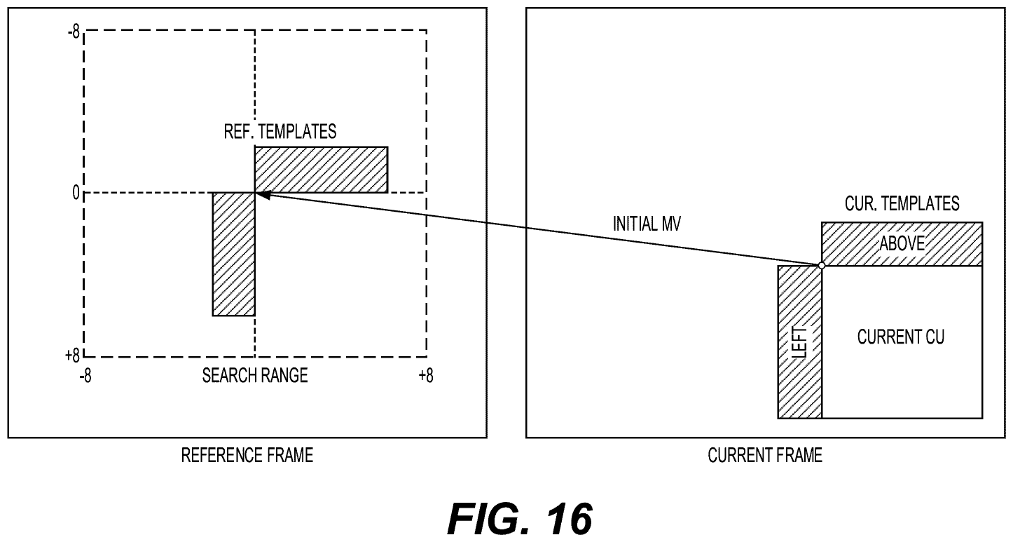

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 16 shows template matching performs on a search area around initial MV. As illustrated in FIG. 16, a better MV is searched around the initial motion of the current CU within a [−8, +8]-pel search range. The template matching method in JVET-J0021 is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 3
Search patterns of AMVR and merge mode with AMVR.

| | AMVR mode | | | | | |
|---|---|---|---|---|---|---|
| | 4- | Full- | Half- | Quarter- | Merge mode | |
| Search pattern | pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 3 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 14. Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### (1) First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0 \_pass 1 = MV 0 + deltaMV$$

$$MV 1 \_pass 1 = MV 1 - deltaMV$$

### (2) Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

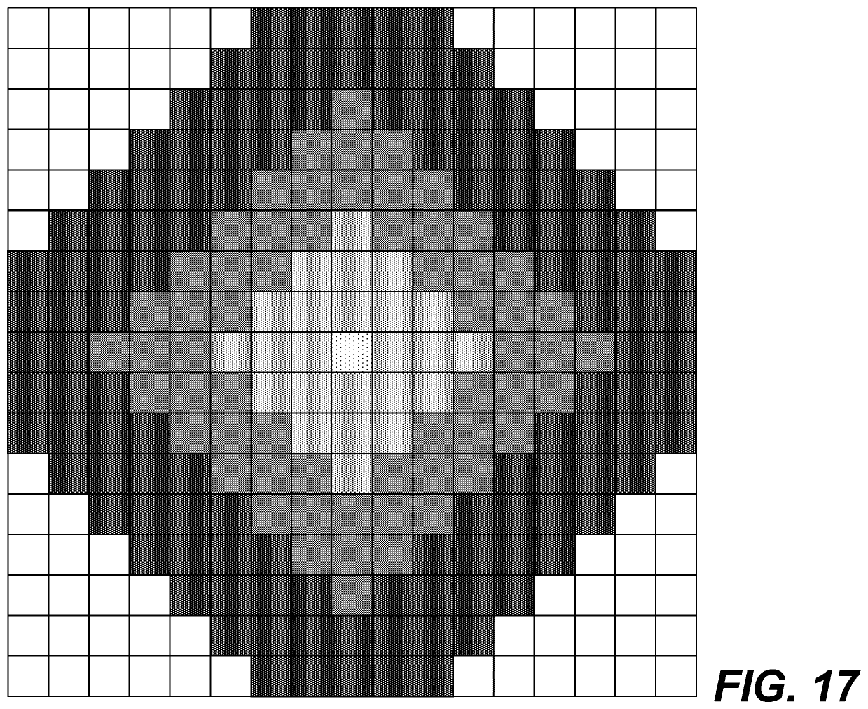

The bilateral matching cost is calculated by applying a cost factor to the SATD cost between two reference subblocks, as: bilCost=satdCost*costFactor. FIG. 17 shows diamond regions in the search area. The search area (2*sHor+1)*(2*sVer+1) is divided up to 5 diamond shape search regions shown on FIG. 17. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV(sbIdx2). The refined MVs at second pass is then derived as:

$$MV 0 \_pass 2 ( s b Idx 2 ) = MV 0 \_pass 1 + deltaMV ( s b Idx 2 )$$

$$MV 1 \_pass 2 ( sbIdx 2 ) = MV1\_pass 1 - deltaMV ( sbIdx 2 )$$

### (3) Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV 0 \_pass3 ( s b Idx 3 ) = MV 0 \_pass2 ( s b Idx 2 ) + bioMv$$

$$MV 1 \_pass3 ( s b Idx 3 ) = MV 0 \_pass 2 ( s b Idx 2 ) - bioMv$$

### 14. Bilateral Matching AMVP-Merge Mode

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signaled as a regular uni-directional AMVP, i.e. reference index and MVD are signaled, and it has a derived MVP index if template matching is used or MVP index is signaled when template matching is disabled.

For AMVP direction LX, X can be 0 or 1, the merge part in the other direction (1−LX) is implicitly derived by minimizing the bilateral matching cost between the AMVP predictor and a merge predictor, i.e. for a pair of the AMVP and a merge motion vectors. For every merge candidate in the merge candidate list which has that other direction (1−LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signaled to indicate which merge candidate in the sorted merge candidate list to use. When there is only one candidate in merge candidate list, the pair of AMVP MVP and merge MVP without bilateral matching MV refinement is padded.

### 15. Chroma Format Sampling Structure

In monochrome sampling there is only one sample array, which is nominally considered the luma array.

In 4:2:0 sampling, each of the two chroma arrays has half the height and half the width of the luma array.

In 4:2:2 sampling, each of the two chroma arrays has the same height and half the width of the luma array.

In 4:4:4 sampling, each of the two chroma arrays has the same height and width as the luma array.

The number of bits necessary for the representation of each of the samples in the luma and chroma arrays in a video sequence is in the range of 8 to 16, inclusive.

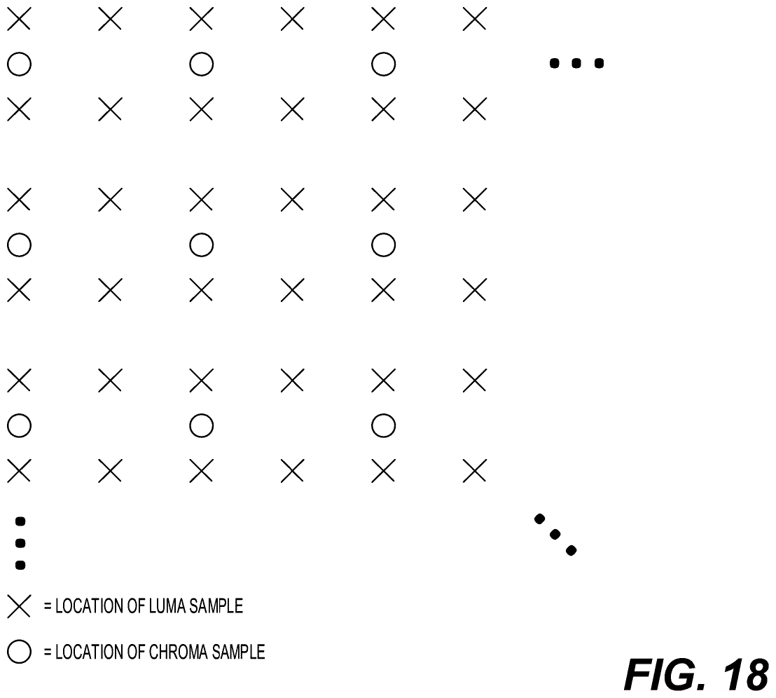

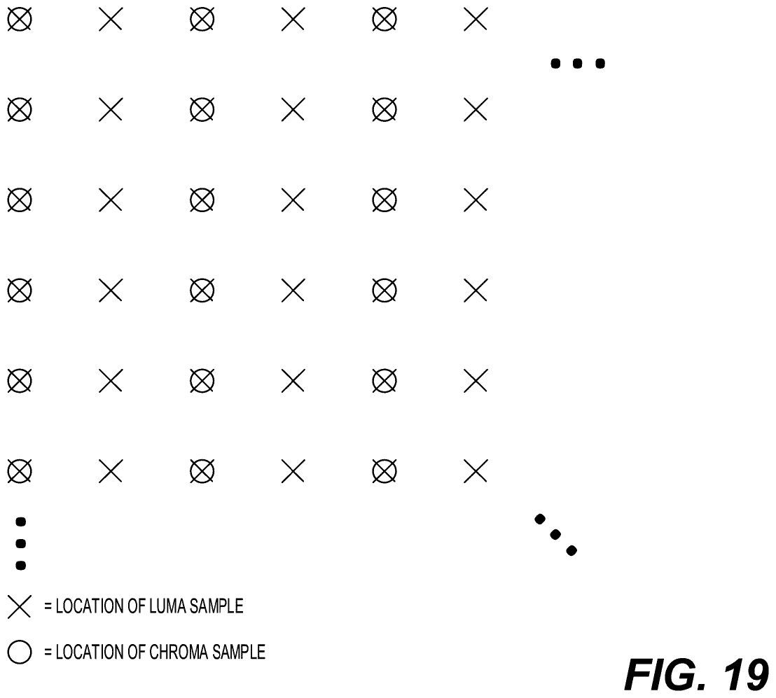

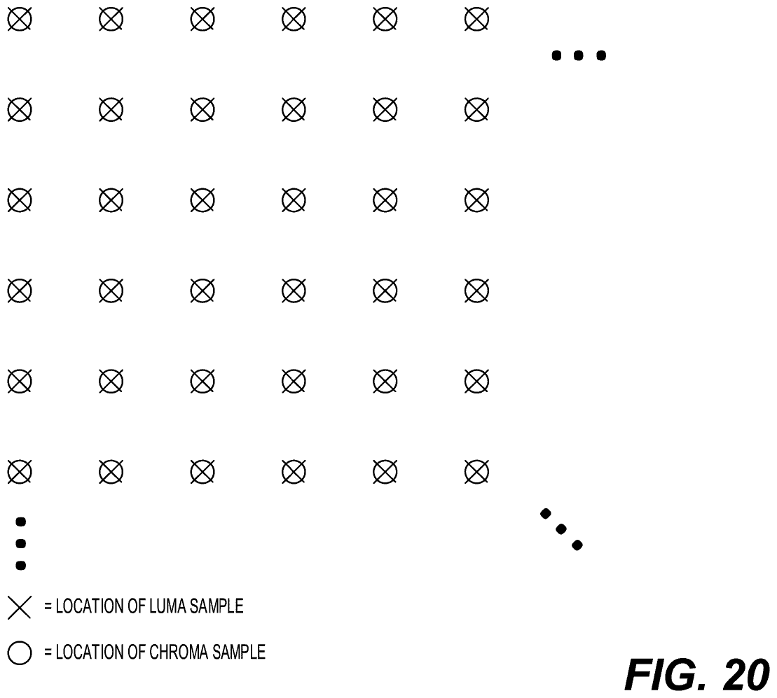

FIG. 18 shows nominal vertical and horizontal locations of 4:2:0 luma and chroma samples in a picture. FIG. 19 shows nominal vertical and horizontal locations of 4:2:2 luma and chroma samples in a picture. FIG. 20 shows nominal vertical and horizontal locations of 4:4:4 luma and chroma samples in a picture.

When the value of sps_chroma_format_idc is equal to 1, the nominal vertical and horizontal relative locations of luma and chroma samples in pictures are shown in FIG. 18. Alternative chroma sample relative locations can be indicated in VUI parameters as specified in Rec. ITU-T H.274 ISO/IEC 23002-7.

When the value of sps_chroma_format_idc is equal to 2, the chroma samples are co-sited with the corresponding luma samples and the nominal locations in a picture are as shown in FIG. 19.

When the value of sps_chroma_format_idc is equal to 3, all array samples are co-sited for all cases of pictures and the nominal locations in a picture are as shown in FIG. 20.

16. Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs, non-adjacent, HMVPs, pairwise, virtual merge candidates. Then the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signaled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

### (1) Cost Calculation

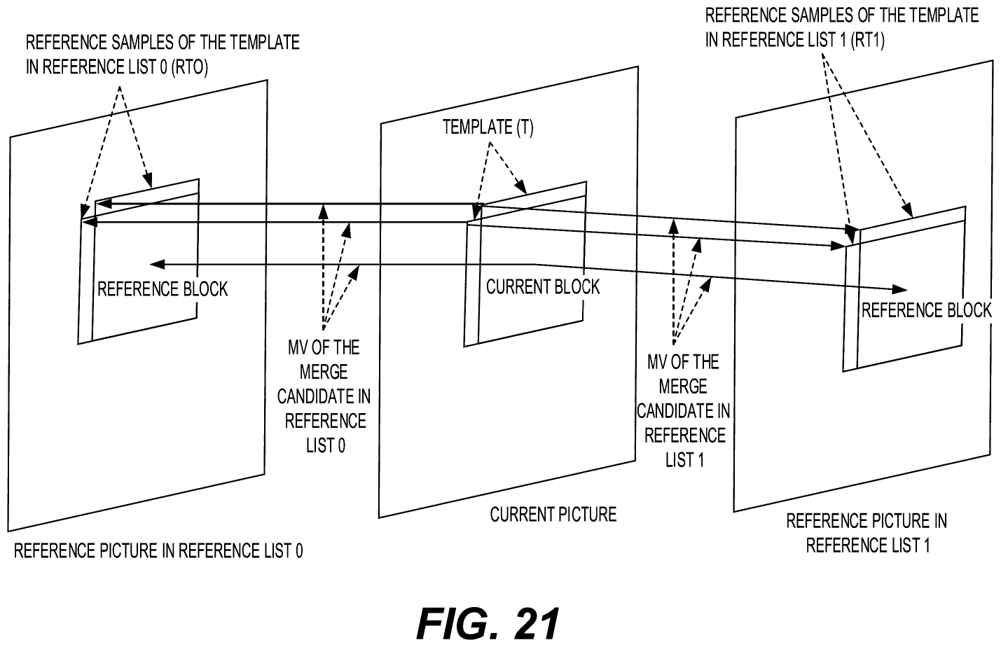

FIG. 21 shows template and reference samples of the template in reference pictures.

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 21.

### (2) Refinement of the Initial Merge Candidate List

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

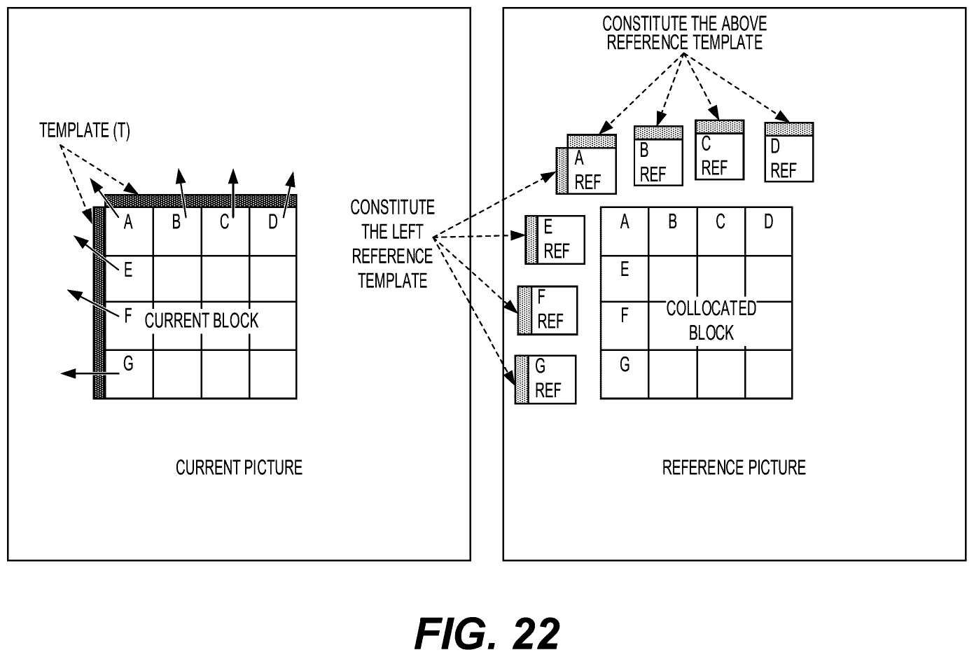

FIG. 22 shows template and reference samples of the template for block with sub-block motion using the motion information of the subblocks of the current block.

For subblock-based merge candidates with subblock size equal to Wsub×Hsub, the above template comprises several sub-templates with the size of Wsub×1, and the left template comprises several sub-templates with the size of 1×Hsub. As shown in FIG. 22, the motion information of the subblocks in the first row and the first column of current block is used to derive the reference samples of each sub-template.

### (3) Reordering Criterial

In the reordering process, a candidate is considered as redundant if the cost difference between a candidate and its predecessor is inferior to a lambda value e.g. |D1−D2|<λ, where D1 and D2 are the costs obtained during the first ARMC ordering and λ is the Lagrangian parameter used in the RD criterion at encoder side.

The proposed algorithm is defined as the following:
Determine the minimum cost difference between a candidate and its predecessor among all candidates in the list
   If the minimum cost difference is superior or equal to λ, the list is considered diverse enough and the reordering stops.
   If this minimum cost difference is inferior to λ, the candidate is considered as redundant and it is moved at a further position in the list. This further position is the first position where the candidate is diverse enough compared to its predecessor.
The algorithm stops after a finite number of iterations (if the minimum cost difference is not inferior to X).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side for low delay configuration and to the value λ corresponding to a another QP for Random Access configuration. A set of λ values corresponding to each signaled QP offset is provided in the SPS or in the Slice Header for the QP offsets which are not present in the SPS.

### (4) Extension to AMVP Modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

### 17. MV Candidate Type Based ARMC

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

### 18. TM Based Reordering for MMVD and Affine MMVD

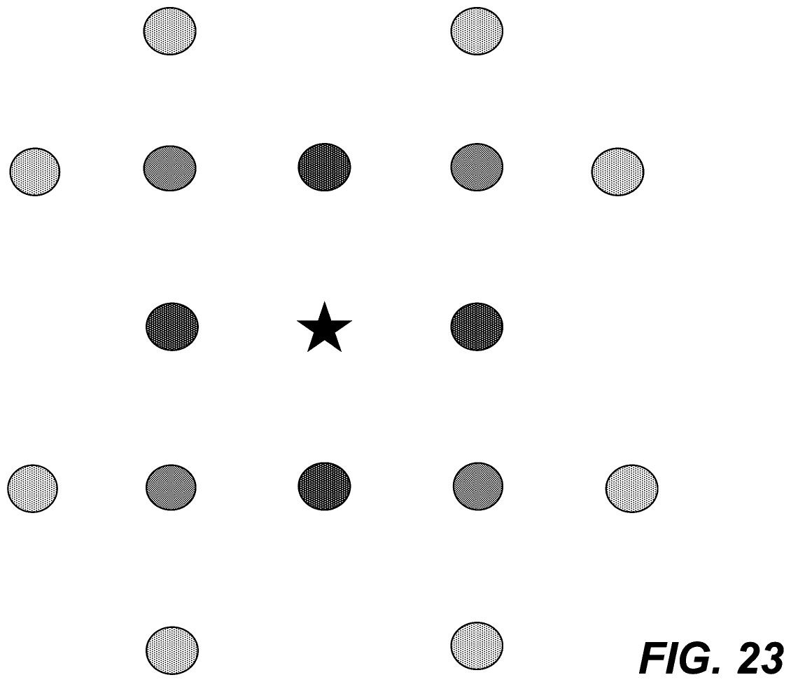

FIG. 23 shows additional directions along k×π/8 diagonal angles (red positions are used in the anchor).

The MMVD offsets are extended for MMVD and affine MMVD modes. Additional refinement positions along k×π/8 diagonal angles are added shown in FIG. 23, thus increasing the number of directions from 4 to 16. Second, based on the SAD cost between the template (one row above and one column left to the current block) and its reference for each refinement position, all the possible MMVD refinement positions (16×6) for each base candidate are reordered. Finally, the top ⅛ refinement positions with the smallest template SAD costs are kept as available positions, consequently for MMVD index coding. The MMVD index is binarized by the rice code with the parameter equal to 2. The affine MMVD reordering is extended, in which additional refinement positions along k×π/4 diagonal angles are added. After reordering top ½ refinement positions with the smallest template SAD costs are kept.

The first N motion candidates in the candidate list before being reordered are utilized as the base candidates for MMVD and affine MMVD. N is equal to 3 for MMVD, and [1, 3] depending on the neighboring block affine flags for affine MMVD. Two ways of adding MMVD offsets are allowed, including the ‘two-side’ and ‘one-side’, depending on whether the offset of the other reference picture list is mirrored or directly set to zero. Which way is applied to one block is dependent on the TM cost.

### II. Proposed Method

In this invention, when not specified, the size is given in the unit of luma samples in a coding unit (CU). And the size of a block is given in the unit of samples in that block. Moreover, in this document, the block size is denoted as W×H where W is the width and H is the height.

Normally, smallest coding blocks are defined in the existing Video codec; for example, 4×4 luma block is the smallest block size for a regular inter modes in ECM6.0 while 2×2 chroma block is the smallest block size for a regular inter modes in VVC when the input video uses 4:2:0 chroma sampling format.

In ECM6.0, only the CU with both width and height being larger than or equal to 8 are allowed for affine Merge while the CU with both width and height being larger than or equal to 8 are allowed for affine AMVP mode. It is noted that to perform affine motion compensation for each affine AMVP and affine Merge coded block, each block is divided into subblock (e.g. 4×4) and the motion vector of each subblock is derived according to the affine motion model associated with the current CU. All the subblocks of the current CU perform motion compensation to get the predictors. It is further noted that the chroma block is also divided into 4×4 chroma subblocks for subblock-based affine motion compensation.

In the first embodiment, the block size for Affine Merge and/or Affine AMVP modes is aligned with the block size allowed for the regular Merge and/or regular AMVP mode. With the size constraint removed, the parsing of the related syntax elements can be simplified.

To enable affine Merge and/or AMVP modes on the small block such as 4×4 luma blocks, a corresponding 2×2 chroma block may be smaller than the predefined subblock size (e.g. 4×4). In the case when the chroma block is smaller than the predefined chroma subblock size, a smaller subblock size for chroma block is used (e.g. 2×2) instead.

In the proposed scheme when affine Merge and/or AMVP modes are enabled/allowed on the small blocks such as 4×N/N×4 CUs and the chroma sampling format is 4:2:0, the corresponding chroma block size is 2×(N/2) and (N/2)×2. Since the original subblock size 4×4 for chroma component is too large for this case, the size of the chroma subblock to perform affine motion compensation should also be modified accordingly. In one embodiment, instead of 4×4 block, 2×2 block is always used as the subblock for the affine subblock-based motion compensation.

In yet another embodiment, when the affine motion model is enabled on 4×N/N×4 CUs, 2×2 block is used as the chroma subblock for the affine subblock-based motion compensation. Otherwise, when the affine motion model is enabled on CUs with both width and height are larger than 4, 4×4 block is still used as the chroma subblock for the affine subblock-based motion compensation. In one example, when the affine motion model is enabled on 4×N CUs (width=4, height=N) AMVP mode, the current CU/block is inferred as using 4-parameter affine model (no syntax is required to be signaled to indicate which affine model was used). Only the top-left and bottom-left control point MVs (CPMV) are required to be signaled. In another example, when the affine motion model is enabled on N×4 CUs (width=N, height=4) AMVP mode, the current CU/block is inferred as using 4-parameter affine model. Only the top-left and top-right control point MVs (CPMV) are required to be signaled. In another example, when the affine motion model is enabled on 4×N CUs (width=4, height=N) AMVP mode, the current CU/block is inferred as using 6-parameter affine model, but only the top-left and bottom-left control point MVs (CPMV) are required to be signaled. In another example, when the affine motion model is enabled on N×4 or 4×N CUs AMVP mode, the current CU/block can select to use 4-parameter or 6-parameter affine model, but only two CPMVs (e.g. the top-left and top-right for N×4 CU, the top-left and bottom-left for 4×N CU) are required to be signaled. If the 6-parameter affine model is selected, the third CPMV is derived from the two signaled CPMV.

In yet another embodiment, when the affine motion model is enabled on 4×4 CUs, 2×2 block is used as the chroma subblock for the affine subblock-based motion compensation. Otherwise, when the affine motion model is enabled on 4×N CUs with N being larger than 4, 2×4 block is used as the chroma subblock for the affine subblock-based motion compensation. Otherwise when the affine motion model is enabled on N×4 CUs with N being larger than 4, 4×2 block is used as the chroma subblock for the affine subblock-based motion compensation.

In the proposed scheme when affine Merge and/or AMVP modes are enabled/allowed on the small blocks such as 4×N/N×4 CUs and the chroma sampling format is 4:2:2, the corresponding chroma block size is 2×(N) and (N/2)×4. Since the original subblock size 4×4 for chroma component is too large for this case, the size of the chroma subblock to perform affine motion compensation should also be modified accordingly. In one embodiment, instead of 4×4 block, 2×4 block is always used as the subblock for the affine subblock-based motion compensation.

In yet another embodiment, when the affine motion model is enabled on 4×N/N×4 CUs, 2×4 block is used as the chroma subblock for the affine subblock-based motion compensation. Otherwise when the affine motion model is enabled on CUs with both width and height are larger than 4, 4×4 block is still used as the chroma subblock for the affine subblock-based motion compensation.

In yet another embodiment, when the affine motion model is enabled on 4×4 CUs, 2×4 block is used as the chroma subblock for the affine subblock-based motion compensation. Otherwise when the affine motion model is enabled on 4×N CUs with N being larger than 4, 2×4 block is used as the chroma subblock for the affine subblock-based motion compensation. Otherwise when the affine motion model is enabled on N×4 CUs with N being larger than 4, 4×4 block is used as the chroma subblock for the affine subblock-based motion compensation.

In the proposed scheme when affine Merge and/or AMVP modes are enabled/allowed on the small blocks such as 4×N/N×4 CUs and the chroma sampling format is 4:4:4, the corresponding chroma block size is 4×N and N×4. Since the original subblock size 4×4 for chroma component is too large for this case, the size of the chroma subblock to perform affine motion compensation should also be modified accordingly. In one embodiment, instead of 4×4 block, 2×2 block is always used as the subblock for the affine subblock-based motion compensation.

In yet another embodiment, when the affine motion model is enabled on 4×N/N×4 CUs, 2×2 block is used as the chroma subblock for the affine subblock-based motion compensation. Otherwise when the affine motion model is enabled on CUs with both width and height are larger than 4, 4×4 block is still used as the chroma subblock for the affine subblock-based motion compensation.

In yet another embodiment, when the affine motion model is enabled on 4×4 CUs, 2×2 block is used as the chroma subblock for the affine subblock-based motion compensation. Otherwise when the affine motion model is enabled on 4×N CUs with N being larger than 4, 2×4 block is used as the chroma subblock for the affine subblock-based motion compensation. Otherwise when the affine motion model is enabled on N×4 CUs with N being larger than 4, 4×2 block is used as the chroma subblock for the affine subblock-based motion compensation. In another embodiment, the chroma subblock size can be min(4, N/2)×min(4, N/2).

In one embodiment, the subblock size is dependent on the affine motion model. That is, the MV difference between two subblocks cannot be greater than one predefined threshold. Among the set of supported subblock sizes, the largest subblock size which can satisfy this constraint is selected as the unit for the affine subblock-based motion compensation. For example, the set of supported subblock sizes includes 16×16, 8×8, 4×4, and 2×2. If the MV difference between two 16×16 subblocks is larger than one predefined threshold and the MV difference between two 8×8 subblocks is smaller than or equal to one predefined threshold, then 8×8 is selected as the subblock size. In another case, If the MV difference between two 4×4 subblocks is larger than one predefined threshold and the MV difference between two 2×2 subblocks is smaller than or equal to one predefined threshold, then 2×2 is selected as the subblock size. In another embodiment, if the MV difference between two smallest subblocks is larger than one predefined threshold, then a fallback mechanism is used instead of affine motion compensation. This method can be applied to luma component only, chroma component only, or both luma and chroma components. This constraint can be the MV difference between two subblocks, the difference between two control point MVs with the consideration of CU width/height, or the difference between two control point MVs without the consideration of CU width/height.

In another embodiment, the subblock size is dependent on CU size. For example, the subblock size will be max (p, min(height, width)/q), where p and q are non-zero integers. In another example, it can be max (p, width/q)×max (p, height/q), where p and q are non-zero integers.

In yet another embodiment, the block size depends on the number of affine parameters. For example, when CU is coded with 4-parameter affine model, the block size is 4×4. Otherwise (CU is coded with 6-parameter affine model), the block size is 2×2. In another example, when CU is coded with 6-parameter affine model, the block size is 4×4. Otherwise (CU is coded with 4-parameter affine model), the block size is 4×4. In another embodiment, if the 6-parameter affine model is selected and the CU size is 4×N or N×4, then the 2×4 or 4×2 luma block is used instead of 4×4 luma block. In another embodiment, if the 6-parameter affine model is selected and the CU size is 4×N or N×4, then the 2×2 luma block is used instead of 4×4 luma block.

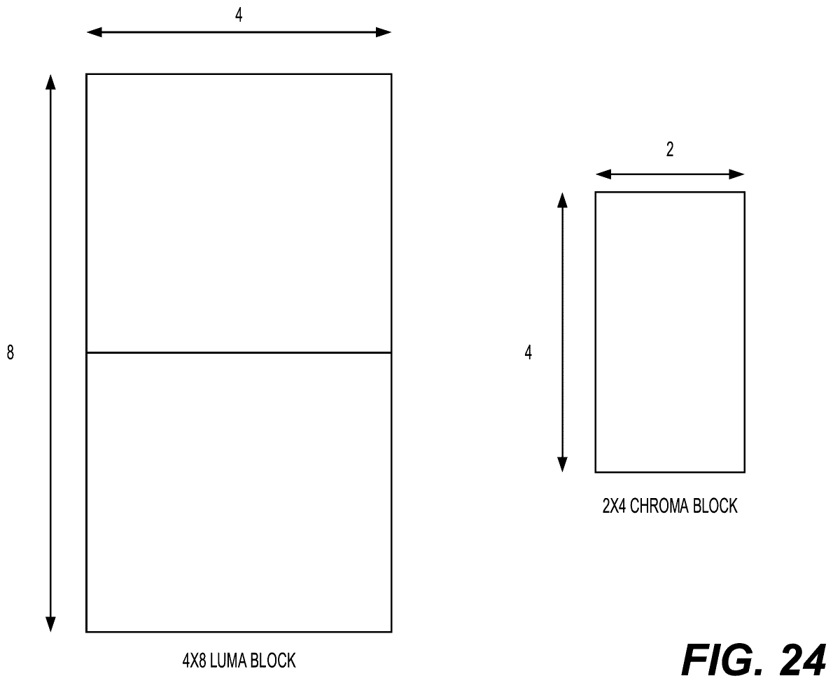

In the VVC and ECM, the my of each chroma subblock is directly derived from the corresponding luma subblocks. In the proposed schemes when 4×4 is used as the subblock size for the luma block and 2×4/4×2 is used as the subblock size for the chroma block, the my of each chroma subblock is derived from the corresponding luma subblocks. In one embodiment, the my of each chroma subblock is derived as the average of the mvs of the two luma subblocks. As illustrated in FIG. 24, when the input video is 4:2:0 chroma sampling, the 2×4 chroma subblock is corresponding to two 4×4 luma subblocks and the my of the 2×4 chroma subblock is derived as the average of the mvs of the two corresponding luma subblocks.

In VVC and ECM-6.0, 6-parameter or 4-parameters affine model could be adaptively selected for an affine AMVP coded block. Since more bits are required to signal the motion information for a 6-parameters affine AMVP mode and small blocks may not need complex motion model such as 6-parameters affine model, it is proposed to disallow 6-parameters affine AMVP mode for small blocks. It is noted that, 6-parameters affine motion model is still allowed for small block size affine merge mode because no extra bits are required for a 6-parameter affine merge mode compared to the 4-parameters one. The small block could be predefined as a CU/PU/block with width being smaller than or equal to L and height being smaller than or equal to M, where L and M could be any non-negative integer. The L and M could be predefined or could be signaled into the bitstream as syntax elements of a video coding standard; and the syntax elements could be signaled at sequence level (e.g. sequence parameter set), picture level (picture parameter set), slice-level (slice header), CTU-level, CU level or block level.

It is noted that in the existed codec, the smallest CU for regular inter mode is 4×4. When the regular inter mode size is allowed for even smaller size such as 2×2 or 1×1. All the methods mentioned in this invention could also be applied with the corresponding block size adjusted accordingly.

To achieve better prediction efficiency of affine motion modes, in this invention, it is also proposed to enable PROF for chroma blocks.

Since small blocks are used for the affine motion modes in the proposed schemes, it is proposed to use 4-taps and/or 2-taps interpolation filters for the luma and chroma subblock compensation for the affine motion modes. In one embodiment, the 2-tap filter could be the bi-linear interpolation filter. In yet another embodiment, the 2-tap interpolation filters and/or 4-taps interpolation filters are only used for the smaller CUs and the other CUs could still use the interpolation filters used by the regular inter modes. The smaller CUs could be defined as the CU with height<=M and width<=N, where M,N are non-negative integers.

In another embodiment, the ARMC is not allowed for affine coded CU/block with it's size, width and/or height is equal to or less than a predefined threshold. For example, ARMC is disallowed for the affine coded CU/block with size equal to 4×4, 4×2 or 2×4.

In another embodiment, the affine MMVD is not allowed for affine coded CU/block with it's size, width and/or height is equal to or less than a predefined threshold. For example, affine MMVD is disallowed for the affine coded CU/block with size equal to 4×4, 4×2 or 2×4.

Any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

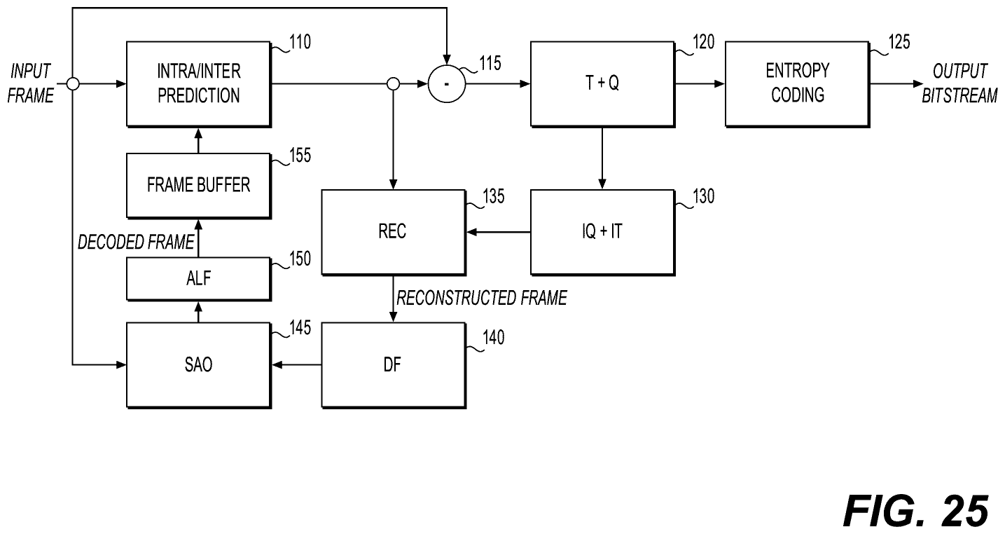

FIG. 25 shows a block diagram of a video encoder that can include or be coupled to a module or circuit implementing the methods and techniques described in the disclosure. The video encoder may be implemented based on the VVC standard, the HEVC standard or any other video coding standard. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 115 to form prediction errors, also called “residues” or “residual”, by subtracting the Intra/Inter prediction signal from the signal associated with the input frame. The process of generating the Intra/Inter prediction data is referred as the prediction process in this disclosure. The prediction error (i.e., the residual) is then processed by Transform (T) followed by Quantization (Q) (T+Q, 120). The transformed and quantized residues are then coded by Entropy Coding unit 125 to be included in a video bitstream corresponding to the compressed video data.

The bitstream associated with the transform coefficients is then packed with side information such as motion, coding modes, and other information associated with the image area. The side information may also be compressed by entropy coding to reduce required bandwidth. Since a reconstructed frame may be used as a reference frame for Inter prediction, a reference frame or frames have to be reconstructed at the encoder end as well. Consequently, the transformed and quantized residues are processed by Inverse Quantization (IQ) and Inverse Transformation (IT) (IQ+IT, 130) to recover the residues. The reconstructed residues are then added back to Intra/Inter prediction data at Reconstruction unit (REC) 135 to reconstruct video data. The process of adding the reconstructed residual to the Intra/Inter prediction signal is referred as the reconstruction process in this disclosure. The output frame from the reconstruction process is referred as the reconstructed frame.

In order to reduce artefacts in the reconstructed frame, in-loop filters, including but not limited to, Deblocking Filter (DF) 140, Sample Adaptive Offset (SAO) 145, and Adaptive Loop Filter (ALF) 150 are used. In this disclosure, DF, SAO, and ALF are all labeled as a filtering process. The filtered reconstructed frame at the output of all filtering processes is referred as a decoded frame in this disclosure. The decoded frames are stored in Frame Buffer 155 and used for prediction of other frames.

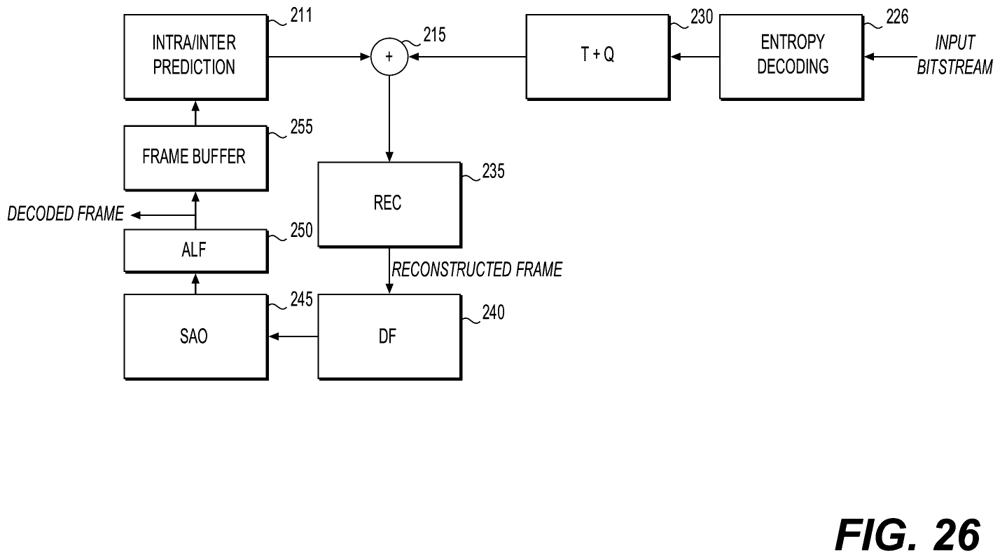

FIG. 26 shows a block diagram of a video decoder that can include or be coupled to a module or circuit implementing the methods and techniques described in the disclosure. The video decoder may be implemented based on the VVC standard, the HEVC standard or any other video coding standard. Since the encoder contains a local decoder for reconstructing the video data, many decoder components are already used in the encoder except for the entropy decoder. At the decoder side, an Entropy Decoding unit 226 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 211 is different from the Intra/Inter prediction unit 110 in the encoder side since the Inter prediction only needs to perform motion compensation using motion information derived from the bitstream. Furthermore, an Adder 215 is used to add the reconstructed residues to the Intra/Inter prediction data.

1. A method for performing affine motion compensation prediction (MCP) in a video decoder, comprising:
selecting an affine MCP mode from an affine MCP mode candidate set; and
performing, based on the selected affine MCP mode, affine motion compensation prediction in the video decoder, wherein
for a coding unit with both a width and a height larger than a first threshold, a first affine MCP mode candidate set is applied,
for a coding unit with at least one of a width and a height not larger than the first threshold, a second affine MCP mode candidate set is applied, and
the first affine MCP mode candidate set has more affine MCP mode candidates than the second affine MCP mode candidate set.

2. The method of claim 1, wherein
the first affine MCP mode candidate set includes:
a 6-parameter affine Advanced Motion Vector Prediction (AMVP) mode, which indicates use of a 6-parameter affine motion model under an affine AMVP mode, and
a 4-parameter affine AMVP mode, which indicates use of a 4-parameter affine motion model under the affine AMVP mode, and
the second affine MCP mode candidate set includes only one of the 6-parameter affine AMVP mode and the 4-parameter affine AMVP mode.

3. The method of claim 2, wherein when the second affine MCP mode candidate set includes the 6-parameter affine AMVP mode,
motion vectors with respect to two control points of the 6-parameter affine motion model are signaled, and
a motion vector with respect to a third control point of the 6-parameter affine motion model is derived from the signaled motion vectors with respect to the two control points.

4. The method of claim 1, wherein
the first affine MCP mode candidate set includes an affine Merge with Motion Vector Difference (MMVD) mode, and
the second affine MCP mode candidate set does not include the affine MMVD mode.

5. The method of claim 1, wherein the first threshold is a predefined value, or is signaled as a syntax element in a bitstream at a sequence level, a picture level, a slice level, a coding tree unit level, a coding unit level, or a block level.

6. The method of claim 1, wherein the first threshold is set at 4.

7. The method of claim 1, wherein when a 4:2:0 chroma sampling format is adopted,
performing, with a subblock size of 4×4 for luma components, and a subblock size of 2×2 for chroma components, the affine motion compensation prediction on the coding unit.

8. The method of claim 1, wherein when a 4:2:0 chroma sampling format is adopted,
for a coding unit having a size equal to 4×N or N×4, where N is a power of 2 and N≥4, performing, with a subblock size of 4×4 for luma components, and a subblock size of 2×2 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

9. The method of claim 1, wherein when a 4:2:0 chroma sampling format is adopted,
for a coding unit having a size equal to 4×4, performing, with a subblock size of 4×4 for luma components, and a subblock size of 2×2 for chroma components, the affine motion compensation prediction on the coding unit,
for a coding unit having a size equal to 4×N, where 4 is a width, N is a height, N is a power of 2, and N>4, performing, with a subblock size of 4×4 for luma components, and a subblock size of 2×4 for chroma components, the affine motion compensation prediction on the coding unit,
for a coding unit having a size equal to N×4, where N is a width, 4 is a height, N is a power of 2, and N>4, performing, with a subblock size of 4×4 for luma components, and a subblock size of 4×2 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

10. The method of claim 1, wherein when a 4:2:2 chroma sampling format is adopted,
performing, with a subblock size of 4×4 for luma components, and a subblock size of 2×4 for chroma components, the affine motion compensation prediction on the coding unit.

11. The method of claim 1, wherein when a 4:2:2 chroma sampling format is adopted,
for a coding unit having a size equal to 4×N or N×4, where N is a power of 2 and N≥4, performing, with a subblock size of 4×4 for luma components, and a subblock size of 2×4 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

12. The method of claim 1, wherein when a 4:2:2 chroma sampling format is adopted,
for a coding unit having a size equal to 4×N, where 4 is a width, N is a height, N is a power of 2, and N≥4, performing, with a subblock size of 4×4 for luma components, and a subblock size of 2×4 for chroma components, the affine motion compensation prediction on the coding unit,
for a coding unit having a size equal to N×4, where N is a width, 4 is a height, N is a power of 2, and N>4, performing, with a subblock size of 4×4 for luma components, and a subblock size of 4×4 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

13. The method of claim 1, wherein when a 4:4:4 chroma sampling format is adopted,
performing, with a subblock size of 4×4 for luma components, and a subblock size of 2×2 for chroma components, the affine motion compensation prediction on the coding unit.

14. The method of claim 1, wherein when a 4:4:4 chroma sampling format is adopted,
for a coding unit having a size equal to 4×N or N×4, where N is a power of 2 and N≥4, performing, with a subblock size of 4×4 for luma components, and a subblock size of 2×2 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

15. The method of claim 1, wherein when a 4:4:4 chroma sampling format is adopted,
for a coding unit having a size equal to 4×4, performing, with a subblock size of 4×4 for luma components, and a subblock size of 2×2 for chroma components, the affine motion compensation prediction on the coding unit,
for a coding unit having a size equal to 4×N, where 4 is a width, N is a height, N is a power of 2, and N>4, performing, with a subblock size of 4×4 for luma components, and a subblock size of 2×4 for chroma components, the affine motion compensation prediction on the coding unit,
for a coding unit having a size equal to N×4, where N is a width, 4 is a height, N is a power of 2, and N>4, performing, with a subblock size of 4×4 for luma components, and a subblock size of 4×2 for chroma components, the affine motion compensation prediction on the coding unit, and
for a coding unit having a width larger than 4 and a height larger than 4, performing, with a subblock size of 4×4 for both luma components and chroma components, the affine motion compensation prediction on the coding unit.

16. The method of claim 1, further comprising determining, based on a size of the coding unit, whether the affine motion compensation prediction is allowed to be performed on the coding unit, wherein
when both the width and the height of the coding unit is equal to or larger than a second threshold, determining that the affine motion compensation prediction is allowed to be performed on the coding unit, and
when at least one of the width and the height of the coding unit is smaller than the second threshold, determining that the affine motion compensation prediction is not allowed to be performed on the coding unit.

17. The method of claim 16, wherein the second threshold is a predefined value, or is signaled as a syntax element in a bitstream at a sequence level, a picture level, a slice level, a coding tree unit level, a coding unit level, or a block level.

18. The method of claim 16, wherein the second threshold is set at 4, 2, or 1.

19. A method for performing affine motion compensation prediction (MCP) in a video encoder, comprising:
selecting an affine MCP mode from an affine MCP mode candidate set; and
performing, based on the selected affine MCP mode, affine motion compensation prediction in the video encoder, wherein
for a coding unit with both a width and a height larger than a first threshold, a first affine MCP mode candidate set is applied,
for a coding unit with at least one of a width and a height not larger than the first threshold, a second affine MCP mode candidate set is applied, and
the first affine MCP mode candidate set has more affine MCP mode candidates than the second affine MCP mode candidate set.

20. (canceled)

21. An apparatus for performing affine motion compensation prediction (MCP) in a video decoder, comprising circuitry configured to
select an affine MCP mode from an affine MCP mode candidate set; and
perform, based on the selected affine MCP mode, affine motion compensation prediction in the video decoder, wherein
for a coding unit with both a width and a height larger than a first threshold, a first affine MCP mode candidate set is applied,
for a coding unit with at least one of a width and a height not larger than the first threshold and the width is larger than or equal to the height, a second affine MCP mode candidate set is applied, and
for a coding unit with at least one of a width and a height not larger than the first threshold and the width is less than the height, a third affine MCP mode candidate set is applied.

22. The apparatus of claim 21, wherein
the first affine MCP mode candidate set includes:
a 6-parameter affine Advanced Motion Vector Prediction (AMVP) mode, which indicates use of a 6-parameter affine motion model under an affine AMVP mode, and
a 4-parameter affine AMVP mode, which indicates use of a 4-parameter affine motion model under the affine AMVP mode, where motion vectors with respect to a top-left and a top-right control points are signaled,
the second affine MCP mode candidate set includes:
a 4-parameter affine AMVP mode, which indicates use of a 4-parameter affine motion model under the affine AMVP mode, where motion vectors with respect to a top-left and a top-right control points are signaled, and
the third affine MCP mode candidate set includes:
a 4-parameter affine AMVP mode, which indicates use of a 4-parameter affine motion model under the affine AMVP mode, where motion vectors with respect to a top-left and a bottom-left control points are signaled.
